(19) United States
(12) Patent Application Publication
(10) Pub. No.: US 2020/0197132 A1
(43) Pub. Date: Jun. 25, 2020

(54) LINGUAL RETAINER

(71) Applicant: HIT Health Intelligent Technologies AG, Pfaeffikon SZ (CH)

(72) Inventor: Markus HIRSCH, Wollerau (CH)

(73) Assignee: HIT Health Intelligent Technologies AG, Pfaeffikon SZ (CH)

(21) Appl. No.: 16/227,102

(22) Filed: Dec. 20, 2018

(51) Int. Cl. A61C 7/08; A61C 7/00; A61C 9/00

(52) U.S. Cl. CPC A61C 7/08; A61C 9/0053; A61C 7/002

(57) ABSTRACT

An orthodontic retainer is configured for application to a lingual surface of a patient's teeth. The retainer is custom designed to exactly match the shape of the lingual side of the patient's teeth and is formed from a plurality of tooth-adhering portions connected by elongated connection portions. The tooth-adhering portions each have a generally flat top edge and a generally curved bottom edge. The connection portions are located at a position below the top edge and above the bottom edge of the tooth-adhering portions. The retainer is formed as a single piece by milling, injection molding or 3D printing.

### BACKGROUND OF THE INVENTION

### 1. Field of the Invention

This invention relates to an orthodontic retainer to maintain teeth in a treated position after orthodontic treatment has been completed. In particular, the invention relates to a lingual retainer that is attached on the lingual face of the teeth, so that the retainer cannot be seen.

### 2. The Prior Art

Orthodontic retainers are used to maintain teeth in a finished position after orthodontic treatment is completed. The retainers can be fixed or removable. One form of orthodontic retainer can be made in many forms. Some retainers are positioned on the lingual side of the teeth and permanently fixed in place. The retainers are formed by brackets that are cemented to the back of the teeth and then connected by a wire. These retainers have the advantage that they cannot be seen, and do not have to be removed while eating. However, they have several disadvantages. One problem with fixed lingual retainers is that they can be bulky, leading to discomfort and even affect the user's speech. In addition, they make it very difficult to clean between the teeth, and around the retainer brackets, increasing the possibility of tooth decay.

### SUMMARY OF THE INVENTION

It is therefore an object of the invention to provide a lingual retainer that avoids the disadvantages listed above and which is comfortable, does not affect speech, and enables thorough cleaning between teeth and around the retainer.

These and other objects are accomplished by an orthodontic retainer configured for application to a lingual surface of a patient's teeth, comprising a plurality of tooth-adhering portions connected by elongated connection portions, the tooth-adhering portions each having a generally flat top edge and a generally curved bottom edge and having a joining side configured to match a curvature of a corresponding tooth of the patient. The connection portions are located at a position below the top edge of the tooth-adhering portions. The tooth-adhering portions and connection portions are formed as a single piece. The tooth-adhering portions preferably cover about 30-80% of the surface area of the patient's teeth, with the connection portions being formed narrower, to expose as much tooth surface as possible between the tooth-adhering portions.

Preferably, the retainer is formed ceramic, composite, or metal. In a particularly preferred embodiment, the retainer is translucent, opaque or fully transparent ceramic or composite material.

In order to make the retainer as comfortable as possible, the retainer is formed to be very thin. In particular, the retainer can be made to be about 0.8 mm thick.

The retainer can be formed using any suitable fabrication methods. In particular, the retainer can be made by any suitable method, such as CNC milling, injection molding, 3D printing composite vacuum forming or any type of additive technology. For all of these methods, a model of the retainer is made based on the shape of the lingual side of the patient's teeth, and sized so that the retainer covers only a pre-set percentage of the tooth area. The retainer can be trimmed to size or molded, milled or printed into the exact size.

The retainer is intended for use after a full treatment with traditional braces or aligners to straighten the patient's teeth. The retainer of the present invention is meant to keep the teeth in the finished position over long periods of time, e.g., 2 months, 1 year, 2 years, or an entire lifetime. The retainer can be used on both the upper and lower sets of teeth, and is adhered to the teeth using standard dental adhesives.

### BRIEF DESCRIPTION OF THE DRAWINGS

Other objects and features of the present invention will become apparent from the following detailed description con-sidered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a front view of the retainer according to the invention;

FIG. 2 shows a view of the retainer attached on the lingual side of a patient's teeth;

FIG. 3 shows a cross-sectional view of a tooth on which the lingual retainer is adhered; and

FIG. 4 shows an alternative embodiment of the invention, with the lingual retainer being applied using a placement jig.

### DETAILED DESCRIPTION OF THE PREFERRED EMBODIMENT

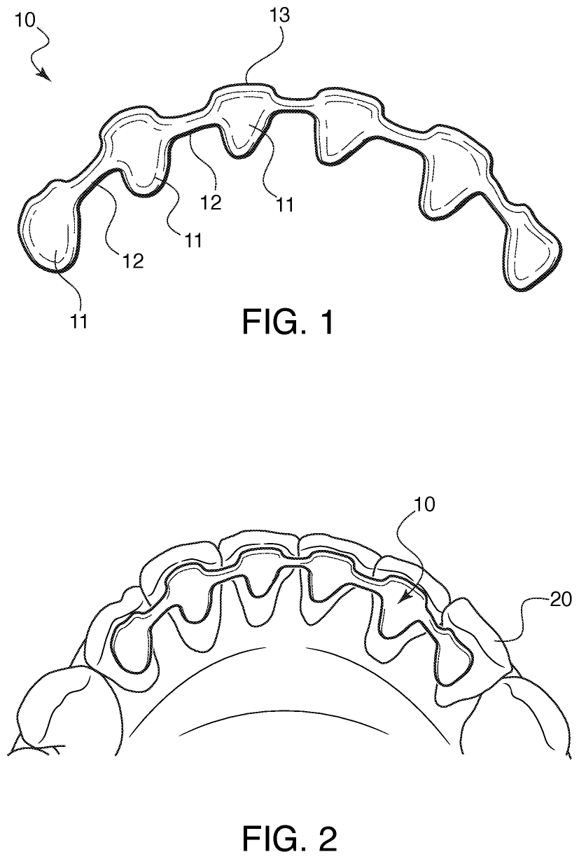

Referring now in detail to the drawings and, FIG. 1 shows a front view of the retainer 10 according to the invention. Retainer 10 comprises a plurality of tooth-adhering portions 11 connected by elongated connection portions 12. Each of the tooth-adhering portions 11 has a generally flat top edge 13 and a generally curved bottom edge 14. The connection portions 12 are located at a position below the top edge 13 of the tooth-adhering portions 11. The tooth-adhering portions 11 and connection portions 12 are formed as a single piece hydride solution, or in several pieces in a single manufacturing process.

FIG. 2 shows the retainer 10 connected to the patient's teeth 20. Retainer 10 has a rear surface that corresponds to the rear (lingual) side of each of the patient's teeth 20 so that it fits securely onto the teeth. The retainer 10 can be bonded to the teeth 20 using any conventional dental bonding material.

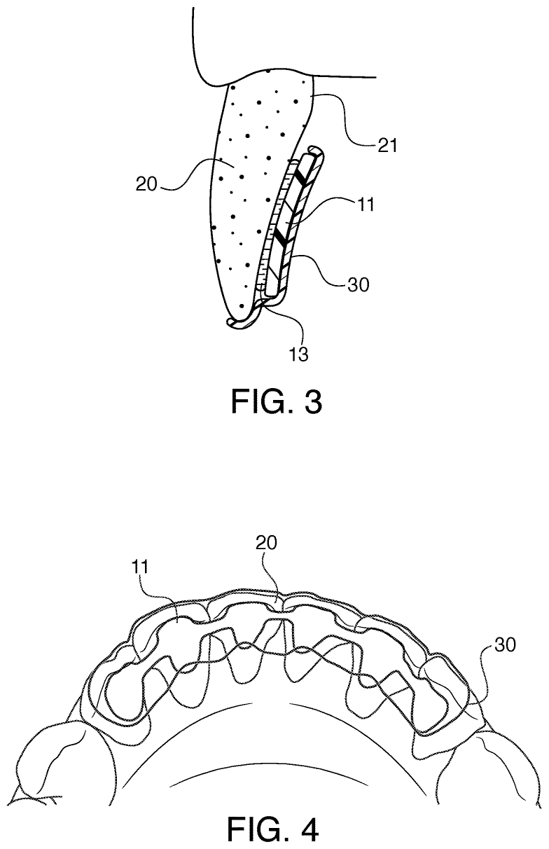

FIG. 3 shows a side view of a tooth 20 to which tooth-adhering portion 11 is attached using an adhesive 13. As can be seen in FIG. 3, the shape of tooth-adhering portion closely follows the shape of the lingual side 21 of the patient's tooth 20. A placement jig 30 can be used to exactly position the retainer on the patient's teeth 20. Jig 30 is formed in the shape of the patient's teeth and fits exactly over the teeth 20. The retainer is fitted into the jig, which is then placed over the teeth and allowed to stay on the teeth while the adhesive of the retainer cures, as shown in FIG. 4. The jig can be manufactured using the same scan of the patient's teeth that is used for form the retainer. The jig can be made using any conventional processes, such as thermoforming.

The retainer according to the invention can be quickly and easily manufactured, and increases patient comfort due to its low profile. It can be manufactured using a transparent or translucent ceramic or composite material, so it is virtually invisible, even from the rear. The retainer allows for simple and effective cleaning of the teeth because the small width of the connection portions leaves plenty of room for brushes and floss to clean and floss the teeth.

Accordingly, while only a few embodiments of the present invention have been shown and described, it is obvious that many changes and modifications may be made thereunto without depar-ting from the spirit and scope of the invention.

What is claimed is:

1. An orthodontic retainer configured for application to a lingual surface of a patient's teeth, comprising:
a plurality of tooth-adhering portions connected by elongated connection portions, the tooth-adhering portions each having a generally flat top edge and a generally curved bottom edge and having a joining side configured to match a curvature of a corresponding tooth of the patient, the connection portions being located at a position below the top edge of the tooth-adhering portions, wherein the tooth-adhering portions and connection portions are formed as a single piece.

2. The orthodontic retainer according to claim 1, wherein the retainer is formed a material selected from the group consisting of ceramic, plastic resin and metal.

3. The orthodontic retainer according to claim 2, wherein the retainer is translucent.

4. The orthodontic retainer according to claim 1, wherein the retainer is about 0.8 mm thick.

5. A method for manufacturing an orthodontic retainer, comprising:
creating a model or scan of at least a lingual side of a patient's teeth,
manufacturing a dental retainer having a front side and a rear side, the rear side being formed to match a shape of the lingual side of the patient's teeth, the dental retainer being formed of tooth-adhering portions connected by connection portions that are narrower than the tooth adhering portions; and
adhering the retainer to the patients teeth using an adhesive, so that the each tooth-adhering portion is connected to a separate one of the teeth.

6. The method according to claim 5, wherein the step of manufacturing is selected from the group consisting of CNC milling, injection molding and 3D printing, composite vacuum forming and additive technology.

7. The method according to claim 5, further comprising placing the retainer in a jig that is formed to correspond to the patients teeth, and placing the jig on the patient's teeth so that the retainer is positioned on the lingual side of the patient's teeth, and removing the jig after the adhesive is cured.
